(19) United States
(12) Patent Application Publication
(10) Pub. No.: US 2008/0041489 A1
(43) Pub. Date: Feb. 21, 2008

(54) Oil supply apparatus

(76) Inventor: Hiyoshi Tatsuno, Minato-ku (JP)

Correspondence Address: JORDAN AND HAMBURG LLP, 122 EAST 42ND STREET, SUITE 4000, NEW YORK, NY, 10168, US

(21) Appl. No.: 10/582,766

(22) Filed: Jun. 13, 2006

(30) Foreign Application Priority Data
Mar. 28, 2006 (JP) PCT/JP06/87358

(51) Int. Cl. B67D 5/08

(52) U.S. Cl. 141/94; 700/232; 705/413

(57) ABSTRACT

An oil supply apparatus includes an oil supply setup apparatus for setting the oil supply in order for clients himself or herself to carry out the oil supply operation; an oil supply mechanism for controlling the oil supply operation on the basis of the oil supply setup content set by the oil supply setup apparatus; and a change payer for settling the oil supply charge in cash due to setting of the oil supply by the oil supply mechanism in one main body case, a change payer has a bill processor for receiving a money by a bill and disbursing the cash when the change is needed of the bill and a coin processor for receiving the money by a coin and disbursing the cash when the change is needed of the coin.

### BACKGROUND OF THE INVENTION

1. Field of the Invention

The present invention relates to an oil supply apparatus of a self-service system, particularly, an oil supply apparatus having a change payer that can perform a cash transaction of an oil supply charge on site in cash.

2. Description of Related Art

Recent years have observed an increasing number of oil supply stations employing a self-service system for clients to render their own services such as for wiping automobile windows, for labor cost reduction, etc. At an oil supply station in such a self-service system, clients also demand that the clients themselves perform the cash transaction of an oil supply charge. Further, associated with an oil supply apparatus in such an oil supply station of a self-service system, the present applicant discloses the art related to an oil supply guiding apparatus that can clearly indicate an oil supply operation guide to be easily checked by clients (for example, refer to Patent document 1).

### [Patent document 1] JP-A-2002-234598 (see pages 2 to 6, FIGS. 1 to 21)

In a conventional oil supply station of a self-service system, clients can easily perform the cash transaction of an oil supply charge using a cash card. However, in case of performing the cash transaction of the oil supply charge in cash, the cash transaction has to be performed at an office of the oil supply station when changes based on an oil supply slip outputted after the completion of the oil supply is needed. Therefore, it is inconvenient that the clients have to visit the office away from the oil supply apparatus with the oil supply slip after the completion of the oil supply work.

### SUMMARY OF THE INVENTION

The present invention has been made taking the foregoing problems into consideration, and an object is to provide an oil supply apparatus, whereby clients can easily perform a cash transaction on site in cash after the completion of an oil supply even if the clients enjoy the oil supply service in cash.

In order to accomplish the above-described object, according to a first aspect of the present invention, there is provided an oil supply apparatus, comprising: an oil supply setup apparatus for setting the oil supply in order for clients themselves to carry out the oil supply; an oil supply mechanism for controlling the oil supply operation on the basis of the oil supply setup content set by the oil supply setup apparatus; and a change payer for settling the oil supply charge in cash on the basis of the oil supply setup by the oil supply mechanism in one main body case; wherein the change payer carries out the process for receiving cash and disbursing cash as change after the completion of the oil supply. Since a change payer is provided, even if the clients enjoy the oil supply service in cash, the cash transaction after the oil supply can be easily performed on site.

According to a second aspect of the present invention, the change payer has a bill processor for receiving paper moneys and disbursing the cash when the change of the bill is needed and a coin processor for receiving a coin and disbursing the cash when the change of the coin is needed. By the bill processor and the coin processor, receiving and disbursing cash is performed.

According to a third aspect of the present invention, the oil supply setup apparatus, the oil supply mechanism, and the change payer are respectively connected through signal lines to a POS terminal that is arranged away from the main body case; the POS terminal receives the oil supply setup content set by the oil supply setup apparatus and receives the money amount information about the money received by the change payer; the POS terminal transmits a signal for allowing oil supply to the oil supply mechanism on the basis of the oil. supply setup content and receives an oil supply finishing signal from the oil supply mechanism; and the POS terminal transmits a signal for instructing the change disbursement to the change payer if the change is needed. The change payer configuring the oil supply apparatus is connected to a POS terminal through a signal line. If clients needs a change, a waiting time for the cash disbursement can be appropriately controlled by receiving a signal to indicate the change disbursement transmitted from the POS terminal.

According to a fourth aspect of the present invention, the change payer is connected to the oil supply mechanism through a signal line for receiving a signal relating to an oil supplying state, and when the signal for instructing the change disbursement from the POS terminal is received after a signal for a temporal stop of the oil supply received by the signal line, the change payer carries out the disbursement process to shift to an idling state after a certain time. In case a change is needed, by appropriately controlling a waiting time, a state of the change payer can be shifted into an idling state.

According to a fifth aspect of the present invention, the oil supply mechanism has an oil supply quantity indicator configured by a back light and an outside light sensor for detecting the brightness of the outside light; and the oil supply mechanism controls the brightness of the back light of the oil supply quantity indicator on the basis of the outside light detected by the outside light sensor. In response to the brightness of the outside light, the brightness of a liquid crystal display provided with a back light is controlled so as to improve visualization of an indicator panel day and night.

According to a sixth aspect of the present invention, the oil supply mechanism has an oil supply quantity indicator configured by a light-emitting diode and an outside light sensor for detecting the brightness of the outside light; and the oil supply mechanism controls the indicated color of the light-emitting diode of the oil supply quantity indicator on the basis of the outside light detected by the outside light sensor. In response to the brightness of the outside light, a display color of an oil supply quantity indicator configured by a light-emitting diode is controlled so as to improve visualization of an indicator panel day and night.

According to a seventh aspect of the present invention, an integrating indicator for indicating the integrating amount of the oil supply quantity measured by the flow meter is attached so that clients can view the integrating amount through an inspection window covered with a polarization plate.

According to the oil supply apparatus, including an oil supply setup apparatus for setting the oil supply in order for clients themselves to carry out the oil supply operation; an oil supply mechanism for controlling the oil supply operation on the basis of the oil supply setup content set by the oil supply setup apparatus; and a change payer for settling the oil supply charge in cash due to setting of the oil supply by the oil supply mechanism in one main body case; the change payer carries out the process for receiving cash and disbursing the cash as the change after the completion of the oil supply. Thereby, even if clients enjoy the oil supply service in cash, the cash transaction can be easily performed after the oil supply on site after completion of the oil supply.

### BRIEF DESCRIPTION OF THE DRAWINGS

FIG. 1 is a front view of an oil supply apparatus that is provided with a change payer according to an embodiment of the present invention;

FIG. 2 is a side view of the oil supply apparatus that is provided with the change payer according to the embodiment of the present invention;

FIG. 3 is a block diagram for explaining the structure of the oil supply apparatus provided with the change payer according to the embodiment of the present invention;

FIG. 4 is an exemplary illustration of an integrating indicator of the oil supply apparatus according to the embodiment of the present invention;

FIG. 5 is a view showing a display procedure of the oil supply apparatus that is provided with the change payer according to the embodiment of the present invention;

FIG. 6 is an exemplary illustration of the operation based on a signal in the oil supplying state, and the money disbursement operation of the change payer according to the embodiment of the present invention;

FIG. 7 is an exemplary illustration of an example of an initial image frame according to the embodiment of the present invention;

FIG. 8 is an exemplary illustration of an example of a welcome image frame according to the embodiment of the present invention;

FIG. 9 is an exemplary illustration of an example of an integrating mode selection image frame according to the embodiment of the present invention;

FIG. 10 is an exemplary illustration of an example of a cash indicating image frame according to the embodiment of the present invention;

FIG. 11 is an exemplary illustration of an example of a money amount confirmation image frame according to the embodiment of the present invention;

FIG. 12 is an exemplary illustration of an example of an oil type selection image frame according to the embodiment of the present invention;

FIG. 13 is an exemplary illustration of an example of an oil supply mode selection image frame according to the embodiment of the present invention;

FIG. 14 is an exemplary illustration of an example of an oil supply quantity selection image frame according to the embodiment of the present invention;

FIG. 15 is an exemplary illustration of an example of an oil supply charge selection image frame according to the embodiment of the present invention; and

FIG. 16 is an exemplary illustration of an example of an oil supply setup selection image frame according to the embodiment of the present invention.

### DESCRIPTION OF THE PREFERRED EMBODIMENTS

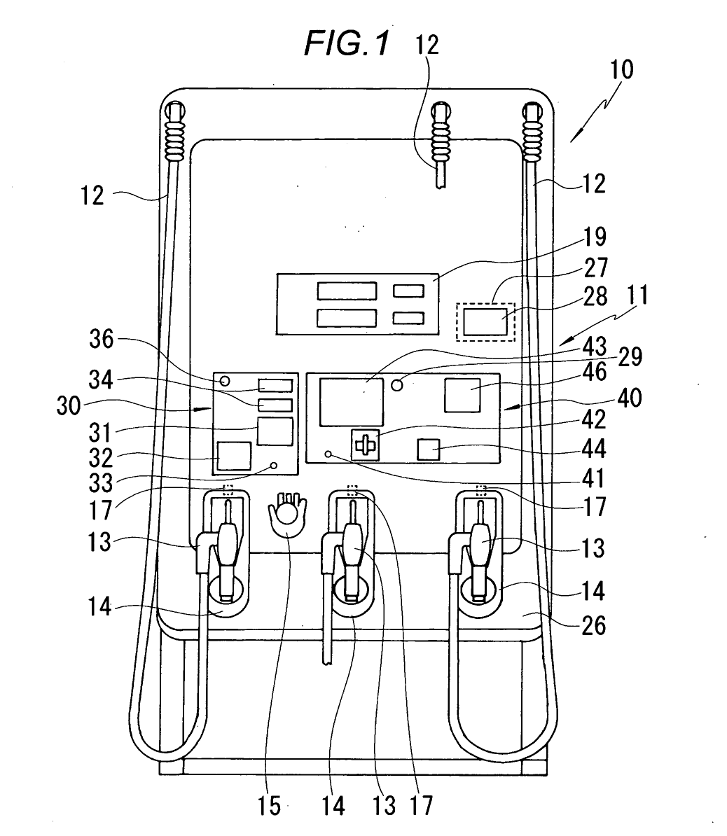

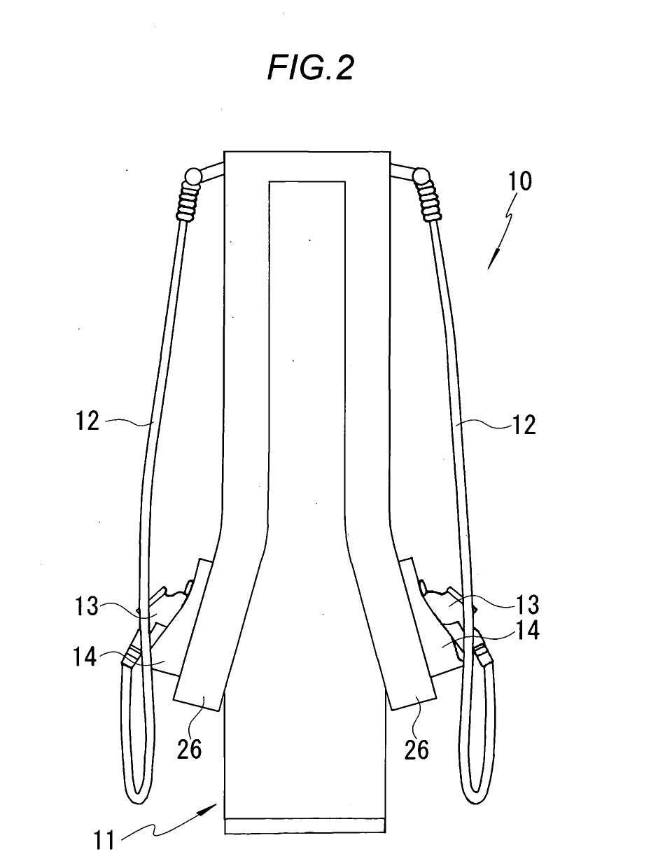

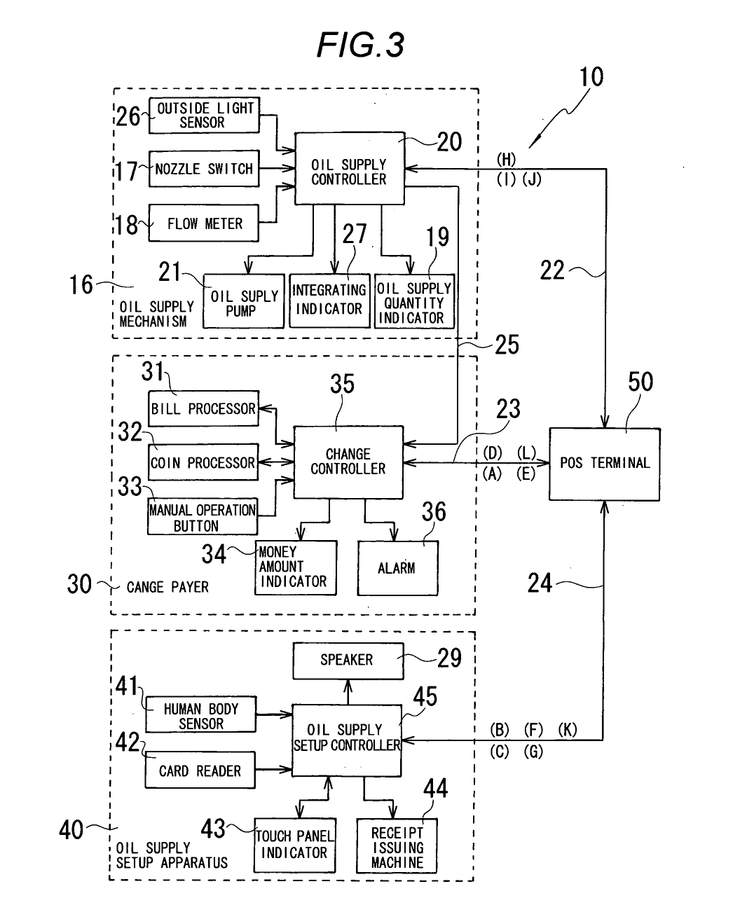

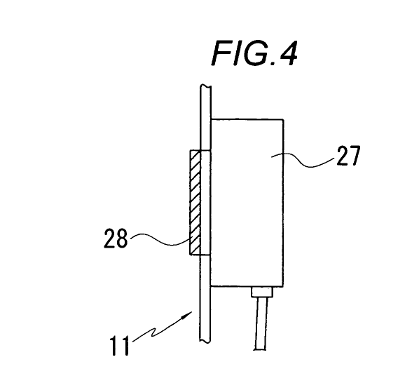

There will be detailed below a preferred embodiment of the present invention with reference to the accompanying drawings. FIGS. 1 to 4 are exemplary illustrations of an oil supply apparatus according to the embodiment of the present invention. Among these drawings, FIG. 1 is a front view of an oil supply apparatus provided with a change payer. FIG. 2 is a side view of the oil supply apparatus that is provided with the change payer. FIG. 3 is a block diagram for explaining the structure of the oil supply apparatus. FIG. 4 is an exemplary illustration of an integrating indicator of the oil supply apparatus.

As shown in these Figures, the oil supply apparatus 10 according to the present embodiment is an on-earth placement type installation which supplies any and all of, for example, a regular gasoline, a hi-octane gasoline, or light oil. A main body case 11 of this oil supply apparatus 10 is formed into nearly a box, and in its lower side, an oil supply mechanism 16 which supplies each oil type is stored. The side of an outlet of this oil supply mechanism 16 is guided to the side of a top part from a pipefitting through the inside of the main body case 11 to be derived to the front side where the oil supply work is carried out and the rear side. Further, an oil supply hose 12 having an oil supply nozzle 13 at the front end is connected to a deriving port of the pipefitting.

The lower parts of the front and rear sides of this main body case 11 are formed into a slope 26 protruding to the operational side as it goes down, and at this slope 26, a nozzle hanger 14 is disposed. The oil supply nozzle 13 hanged up from the top part of the main body case 11 via the oil supply hose 12 is configured so as to be hanged on the nozzle hanger 14. In the vicinity of the nozzle hanger 14, a nozzle switch 17 for detecting a removal of the oil supply nozzle 13 is provided. In addition, in the vicinity of the nozzle hanger 14, a static electricity removing unit 15 to remove a static electricity charged in a human body before starting the oil supply work by touching it.

The oil supply mechanism 16 is configured by the nozzle switch 17, a flow meter 18 for measuring the oil supply quantity, an outside light sensor 26 for detecting the outside light, an oil supply pump 21, an oil supply quantity indicator 19, an integrating indicator 27, and an oil supply controller 20 or the like. For example, the oil supply quantity indicator 19 for indicating the oil supply quantity is a liquid crystal display having a back light or an indicator configured by a light-emitting diode which is disposed at the upper side of the center of the main body case 11. In the vicinity of this oil supply quantity indicator 19, the integrating indicator 27 for indicating the integrating amount of the oil. supply quantity connected to the oil supply controller 20 through the signal line is provided. This integrating indicator 27 is used for a manager at the oil supply station to monitor the operating state of the oil supply apparatus 10, and as shown in FIG. 4, the manager can watch the integrating amount only from a special direction through an inspection window covered with a polarization plate 28. The oil supply controller 20 receives a signal from the nozzle switch 17 and the flow meter 18 so as to control the operation of the oil supply pump 21 and control the display of the oil supply quantity indicator 19 as described later. In addition, the oil supply controller 20 controls the oil supply quantity indicator 19 on the basis of a signal relating to the brightness of the outside detected by the outside light sensor 26. In other words, in case that the oil supply quantity indicator 19 is the liquid crystal display, the oil supply controller 20 controls the intensity of the back light to be increased at daytime and decreased at night. Further, in case that the oil supply quantity indicator 19 is an indicator configured by the light-emitting diode, the oil supply controller 20 controls the oil supply quantity indicator 19 to emit the orange light at daytime and the blue light at night so that the oil supply quantity can be indicated with improved visualization day and night.

At the upper part of the nozzle hanger 14 of the main body case 11, a change payer 30 for carrying out the operation to cash out the oil supply charge in cash and an oil supply setup apparatus 40 for setting the oil supply and carrying out the operation to pay the oil supply charge by a card are mounted.

The change payer 30 is configured by a bill processor 31, a coin processor 32, an manual operation button 33, a money amount indicator 34 for indicating the received money amount and the change, an alarm 36, and a change controller 35 or the like. The bill processor 31 is a part where the coin to be received is read and the disbursement process is carried out when the change is needed of the bill. The manual operation button 33 is a button to be operated when the money has been received. The change controller 35 receives the money received information from the bill processor 31 and the coin processor 32 and receives a signal from the manual operation button 33 so as to control the operation of the money amount indicator 34 and control the operation to disburse the change from the bill processor 31 or the coin processor 32 when the change is needed as described later. The alarm 36 is a part to alarm to press clients for the operation when no operation has been done for a long time after putting the money and alarm clients not to forget the change. Further, the change payer 30 is provided with the bill processor 31, the coin processor 32, the manual operation button 33, the money amount indicator 34, and the alarm 36 at the front side and the rear side of the main base 11, respectively, and they are controlled by one change controller 35.

The oil supply setup apparatus 40 is configured by a human body sensor 41, a card reader 42, a touch panel indicator 43, a receipt issuing machine 44, a speaker 29, and an oil supply setup controller 45 or the like. The human body sensor 41 detects the human body approaching to the oil supply setup apparatus 40 for supplying the oil. The card reader 42 is a part to read a credit card or the like when clients pay the oil supply charge through the card. The touch panel indicator 43 is a part to indicate guiding for setting the oil supply from the start of the oil supply operation till the end thereof and to carry out the operation. The receipt issuing machine 44 is a part to issue the receipt of the oil supply charge when the oil supply operation has been completed. The speaker 29 is a part to guide the operation by voice.

The oil supply controller 20, the change controller 35, and the oil supply setup controller 45 of the oil supply apparatus 10 are connected to a POS terminal 50 arranged at an office or the like away from the oil supply apparatus 10, respectively, through signal lines 22, 23, and 24. This POS terminal 50 is, as described in detail later, a part to transmit and receive a signal to and from the oil supply controller 20, the change controller 35, and the oil supply setup controller 45, respectively, to control the operation from the start of the oil supply of the oil supply apparatus 10 till the end thereof. In addition, this POS terminal 50 is connected to each oil supply apparatus through the signal line as same as the above when there is a plurality of oil supply apparatus at the oil supply station. Further, the oil supply controller 20 and the change controller 35 are connected through the signal line 25 inside of the oil supply apparatus 10. As described in detail later, a signal relating to the oil supplying state from the oil supply controller 20 is transmitted to the change controller 35 via the signal line 25 so as to control the disbursement operation of the change.

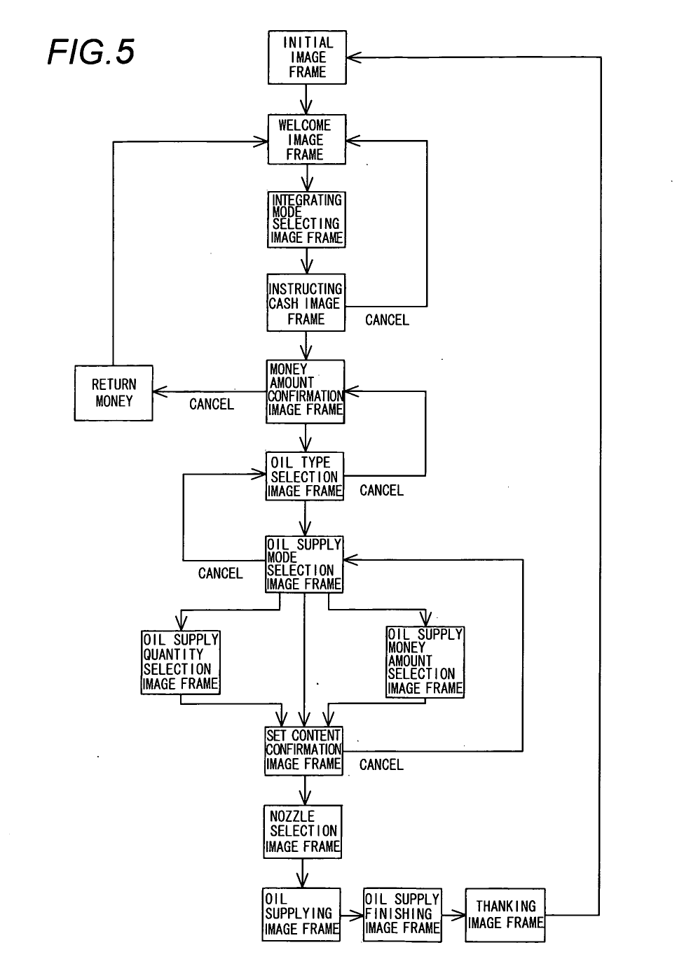

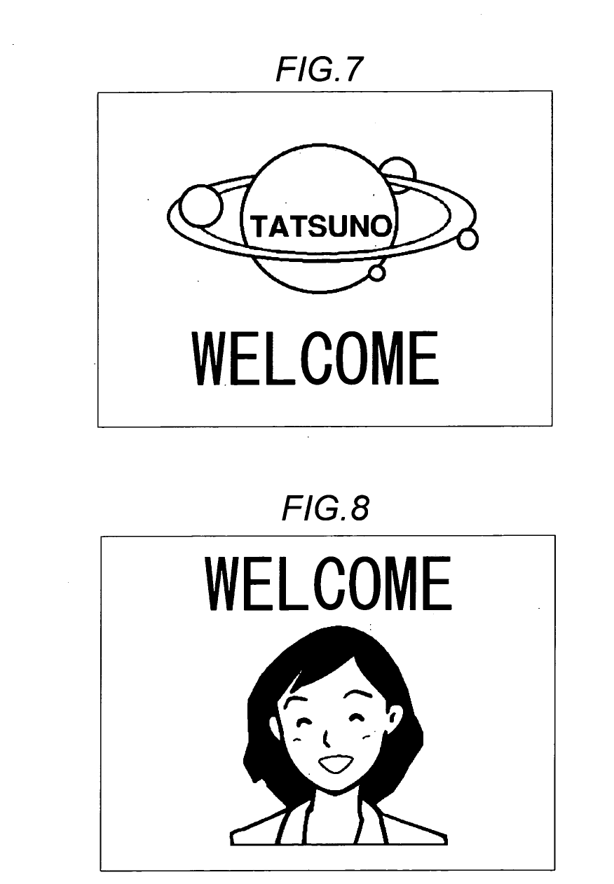

Next, examples of the indication of the touch panel indicator 43 of the oil supply setup apparatus 40 mainly in case that the oil supply charge is settled in cash will be described below. FIG. 5 is a view showing a display procedure of the touch panel indicator of the oil supply setup apparatus, and FIGS. 7 to 20 are exemplary illustrations of the specific example of the image frames.

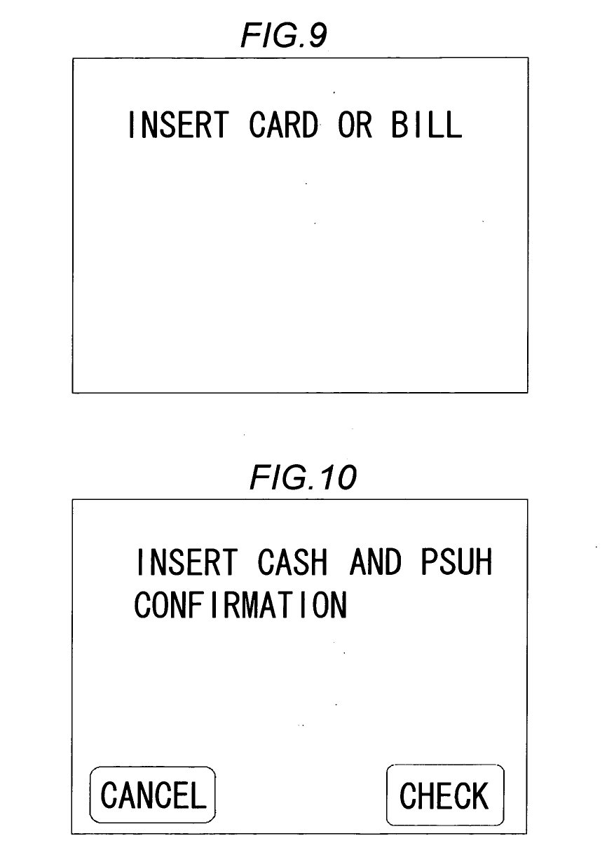

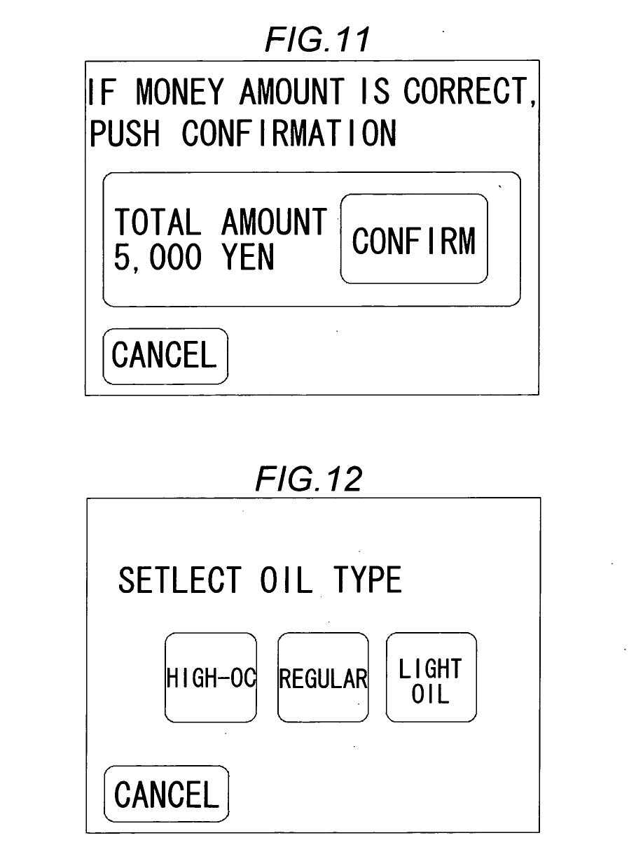

At first, in an oil supply waiting condition of the oil supply apparatus 10, such an initial image frame as shown in FIG. 7. The initial image frame is constituted with still images such an illustration including a letter phrase “WELCOME”. Next, when clients come in front of the oil supply apparatus 10 and the human body sensor 41 detects the human body, a welcome image frame as shown in FIG. 8, namely, the image frame indicating a letter phrase “WELCOME” and the illustration of a woman or the like is indicated. In addition, the voice of “WELCOME” is outputted from the speaker 29, and on the following image frames, the voice for guiding the operation is also outputted. After lapse of a constant display time of the welcome image frame, there is indicated as the integrating mode selection image frame as shown in FIG. 9, a letter phrase “INSERT A CARD OR A BILL”. On the basis of this image frame, if the clients insert the credit card into the card reader 42, the oil supply charge can be settled by the card and if the clients insert the cash into the change payer 30, the oil supply charge can be settled in cash. According to the present embodiment, the case of settling the oil supply charge in cash will be mainly described. Accordingly, in case of settling the oil supply charge in cash, a cash indicating image frame as shown in FIG. 10 is indicated. In the cash indicating image frame, a letter phrase “INSERT CASH AND PUSH A CONFIRMATION BUTTON” is indicated. If the clients push a cancel button, the image frame returns to the welcome image frame, however, if the user pushes the confirmation button, the oil supply charge can be settled in cash. Consequently, for example, if the clients insert the bill amounting to 5,000 yen into the bill processor 31, as shown in FIG. 11, as the money amount confirmation image frame, letter phrases “PUSH THE CONFIRMATION BUTTON IF THE MONEY AMOUNT IS CORRECT” and “TOTAL MONEY AMOUNT 5,000 YEN” are indicated. If the clients push the cancel button on the money amount confirmation image frame, the inserted cash is returned and the image frame returns to the welcome image frame. However, if the clients push the confirmation button, the image frame proceeds to a following oil type selection image frame.

As shown in FIG. 12, on the oil type selection image frame, a rectangular button indicating high-octane, regular, and a light oil, and the cancel button are indicated at the lower part of a letter phrase “SELECT THE OIL TYPE”. On this oil type selection image frame, if the clients push any and all of the oil type selection buttons, the selected oil type is selected, and if the clients pushe the cancel button, the image frame returns to the money amount confirmation image frame.

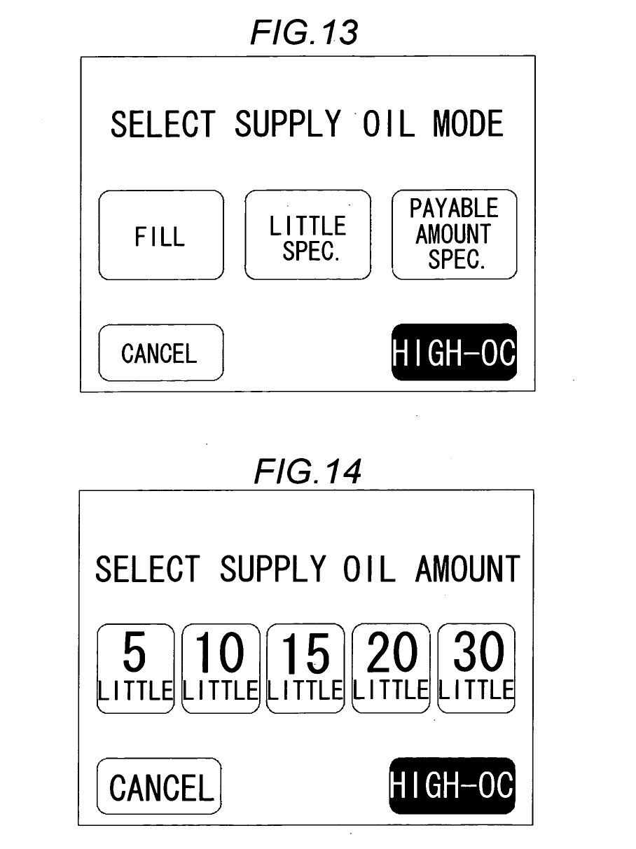

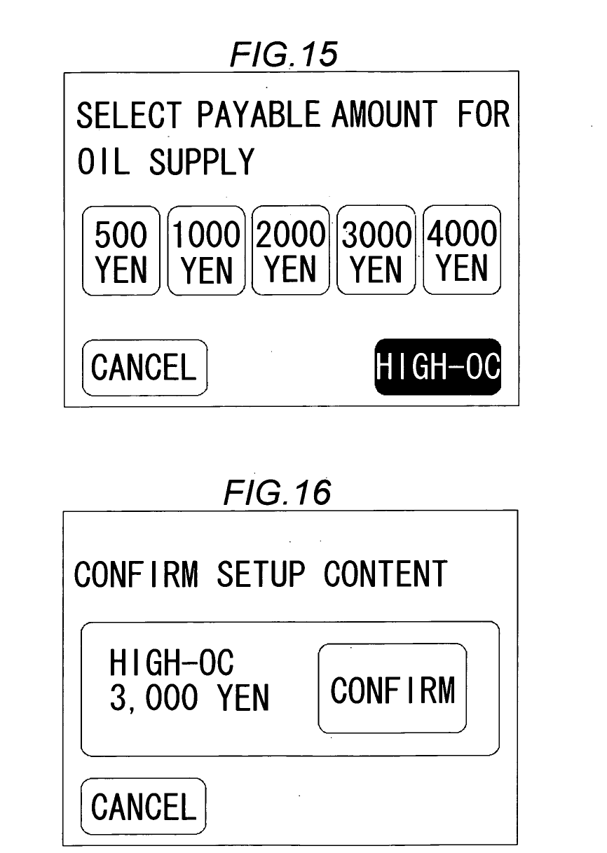

Next, as an oil type is selected in the oil type selection image frame, there is displayed an oil supply mode selection image frame to be such a setup image frame as shown in FIG. 13. This oil supply mode selection image frame has under a letter phrase “SELECT OIL SUPPLY MODE”, rectangular buttons indicated a fill of tank, a litter specification, and a money amount specification, and a cancel button, in addition, a letter indication of the selected oil type, such as “HIGH-OC.” As the litter specification or money amount specification button is pressed in the oil supply mode selection image frame, there is displayed a litter specification image frame or money amount specification image frame, respectively. If the fill button is pressed, there is displayed a later-described oil supply setup confirmation image frame. If the cancel button is pressed, the display returns to the oil supply mode selection image frame. The litter specification image frame is an image frame for selection of a specified quantity of oil to be supplied in litter, and as a setup image frame such as shown in FIG. 14 has therein buttons of 5 lit., 10 lit. 15 lit., 20 lit., and 30 lit., and a cancel button, in addition, a letter indication of the selected oil type, such as “HIGH-OC.”. If any litter button is pressed in the litter specification image frame, there is displayed a subsequent. setup content confirmation image frame. If the cancel button is pressed, the display returns to the oil supply mode selection image frame. The oil supply money amount specification image frame is an image frame for selection of an oil quantity payable by a specified amount of money, and as a setup image frame such as shown in FIG. 15 has therein buttons of 500 Yen, 1000 Yen, 2000 Yen, 3000 Yen, and 4000 Yen, and a cancel button, in addition, a letter indication of the selected oil type, such as “HIGH-OC.” If any money amount button is pressed in the money amount specification image frame, there is displayed a subsequent setup content confirmation image frame. If the cancel button is pressed, the display returns to the oil supply mode selection image frame.

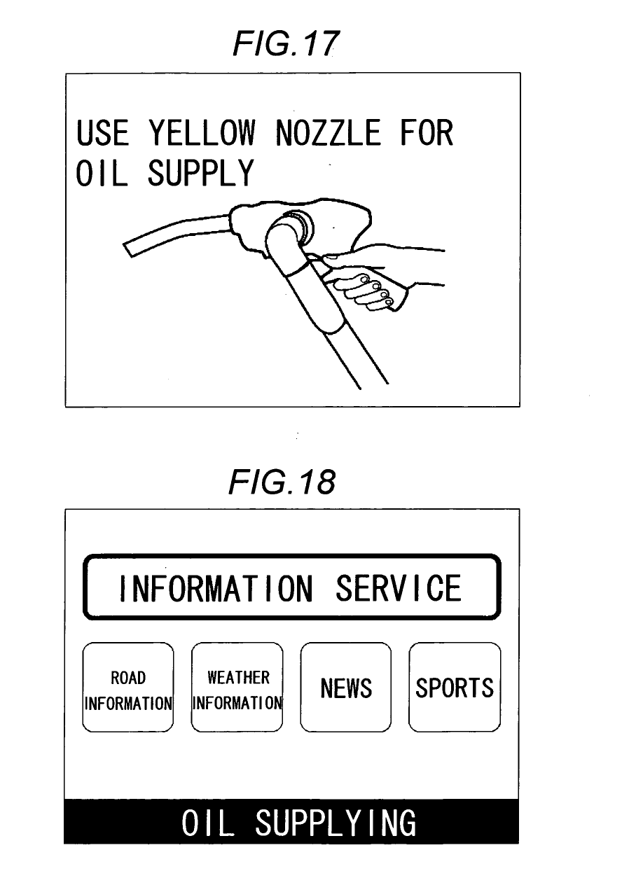

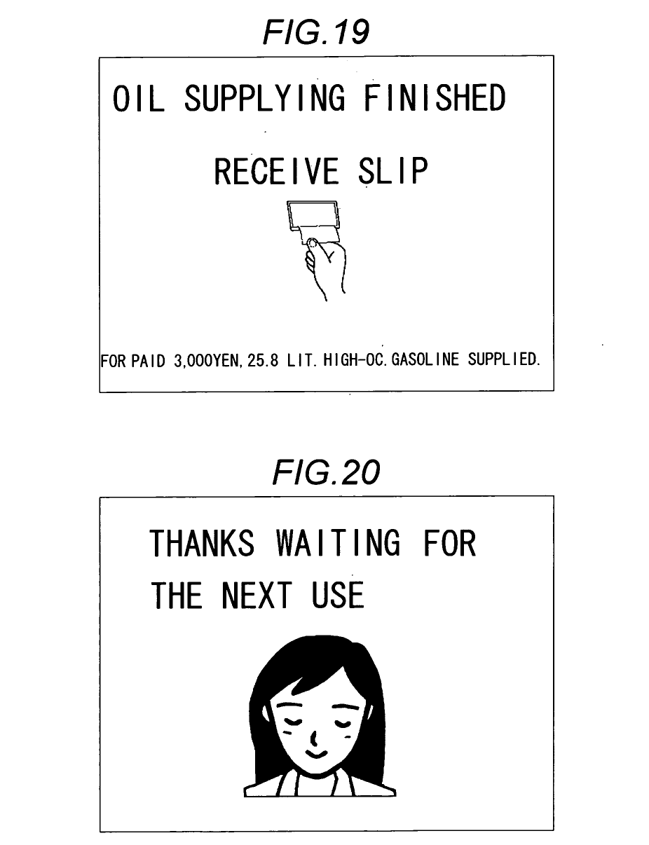

Next, as shown in FIG. 16, a setup content confirmation image frame is displayed as an image frame for confirmation of a selected item in a previous setup image frame. This image frame has letter indications of selected “HIGH-OC.” and “3000 Yen” and a button of confirmation neighboring thereto, in addition, a cancel button under a letter phrase “CONFIRM SETUP CONTENT”. If the confirmation button is pressed in the setup content confirmation image frame, there is displayed a oil supply nozzle selection image frame. If the cancel button is pressed, the display returns to the oil supply mode selection image frame, to again perform selections of an oil supply mode.

As shown in FIG. 17, this nozzle selection image frame has a letter phrase “USE YELLOW NOZZLE FOR OIL SUPPLY”, and an illustration indicated with an oil supply nozzle in hand. Following this indication, when the oil supply nozzle 13 is removed from the nozzle hanger 14, there is displayed an oil supplying image frame as a selection image frame shown in FIG. 18. This oil supplying image frame has, under a letter indication “INFORMATION SERVICE”, buttons indicated with letters of road information, weather information, news, and sports, and thereunder, a letter indication of “OIL SUPPLYING”. If any of those buttons is pressed, there is displayed corresponding service information during the oil supply. Concrete examples of this service information are omitted.

Next, after the oil supply is finished, as oil supply nozzle 13 is hung on the nozzle hanger 14, there is displayed such an oil supply finish image frame as shown in FIG. 19. This oil supply finish image frame has a letter phrase “OIL SUPPLY IS FINISHED, RECEIVE SLIP”, an illustration indicating a condition in which a receipt of the receipt issuing machine 44 is taken by hand, and a lower letter indication “25.8 LIT. HIGH-OC. GASOLINE FOR 3000 YEN, SUPPLIED”. After lapse of a constant time during which the oil supply finish image frame was kept displayed, there is displayed such a subsequent thank image frame as shown in FIG. 20. This thank image frame indicates a letter phrase “THANK YOU, WAITING FOR NEXT USE” with an illustration such as of a woman. After lapse of a constant time during which the thanking image frame was kept displayed, the display returns to an initial image frame, entering a subsequent waiting condition.

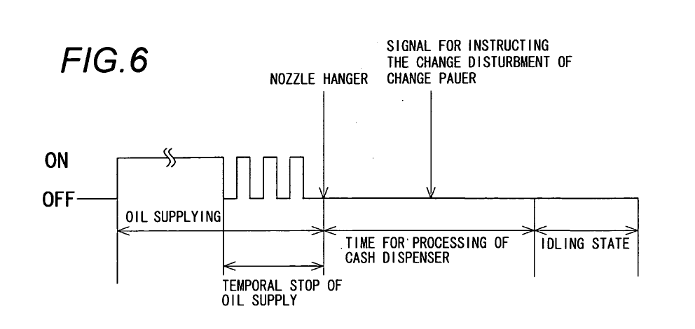

Next, the operation in case of settling the oil supply charge in cash will be specifically described with reference to FIG. 3 and FIG. 6.

At first, in order to settle the oil supply charge in cash, in the change payer 30, if the clients insert the bill into the bill processor 31 or insert the coin in the coin processor 32 and subsequently, if the manual operation button 33 is pushed, a signal (A) indicating money insertion is transmitted to the POS terminal 50 from the change controller 35 via the signal line 23. Receiving this signal (A) indicating money insertion, the POS terminal 50 transmits a signal (B) indicating a switching of an image frame switched to the oil supply setup controller 45 via the signal line 24. When the oil supply setup apparatus 40 receives this signal (B) indicating the switching of an image frame, for example, the cash indicating image frame as shown in FIG. 10 is indicated on the touch panel indicator 43. If the confirmation button on this cash indicating image frame is pushed, a signal (C) for confirmation of cash insertion as shown in FIG. 10 is transmitted from the oil supply setup apparatus 40 to the POS terminal 50 via the signal line 24. Next, receiving the signal (C) for confirmation of cash insertion, the POS terminal 50 transmits a signal (D) for money insertion request to the change controller 35 via the signal line 23. For example, in case of supplying the hi-octane gasoline amounting to 3,000 yen, if the money 5,000 yen is inserted, a signal (E) showing that the money amount 5,000 yen is inserted is transmitted to the POS terminal 50 via the signal line 23. In addition, on the money amount indicator 34 of the change payer 30, this is indicated as a deposit 5,000 yen, and at the same time, on the touch panel indicator 43 of the oil supply setup apparatus 40, this is indicated as the deposit 5,000 yen as shown in FIG. 11. Subsequently, by pushing a desired button for a oil supply as shown in FIGS. 11 to 16, a signal (G) set by the operation to the POS terminal 50 is outputted, and determining the signal, the POS terminal 50 outputs a signal (F) for a switching of an image frame to the oil supply setup apparatus 40. Pushing the confirmation button in FIG. 16, the last signal (G) is outputted to the POS terminal 50 and a signal (H) for allowing the oil supply is transmitted to the oil supply controller 20 via the signal line 22. Further, as shown in FIG. 17, taking off the indicated predetermined oil supply nozzle 13 from the nozzle hanger 14, the nozzle switch 17 is turned on to start the oil supply. Then, a signal (I) indicating the oil supplying state including the oil supply quantity measured by the flow meter 18 is transmitted to the POS terminal 50 via the signal line 22, and as shown in FIG. 18, the image frame is switched. In addition, if the hi-octane gasoline attains to the set amount such as 3,000 yen or the like and the nozzle switch 17 is turned off, an oil supply finishing signal (J) is transmitted from the supply controller 20 to the POS terminal 50 via the signal line 22. Receiving this oil supply finishing signal (J), the POS terminal 50 transmits a signal (K) for a switching of an image frame showing the end of the oil supply to the oil supply setup controller 45. Receiving this signal (K) for a switching of the image frame showing the end of the oil supply, the oil supply setup apparatus 40 issues the receipt of the settlement of the oil supply by the receipt issuing machine 44 with the image frame switched as shown in FIG. 19. Subsequently, the POS terminal 50 transmits a signal (L) for instructing the change disbursement to the change controller 35 when the change is needed.

Next, the disbursement operation of the change of the change payer 30 will be described below. FIG. 6 is an exemplary illustration of the operation based on a signal in the oil supplying state and the money disbursement operation of the change payer 30. The change payer 30 makes the shift to a waiting time till the disbursement process is completed (time when there is a plurality of oil supply apparatus 10 at the oil supply station and the POS terminal 50 outputs a signal for instructing the change disbursement to each oil supply apparatus 10) after the end of the oil supply (namely, the nozzle switch 17 is turned off). If there is no need of the change, the POS terminal 50 receives the signal in the oil supplying state from the oil supply controller 20 so that the change payer 30 makes the shift to an idling state after lapse of a certain time. In other words 14 is transmitted a signal for a temporal stop of the oil supply to be continued till the oil supply nozzle 13 is hung on the nozzle hanger. In FIG. 6, this signal is turned on during the oil supplying and when the oil supply is temporally stopped, this signal repeats on and off at certain intervals of 0.5 second, for example. The change payer 30 receives an off signal of the nozzle switch 17 and the disbursement instruction becomes in the waiting condition to wait for a signal for instructing the change disbursement. Receiving the signal for instructing the change disbursement, the POS terminal 50 returns to the idling state after the completion of the disbursement. In addition, not receiving a signal (L) for instructing the change disbursement, the change payer 30 determines that there is no need of the change and shifts to the idling state when a waiting time, for example ten seconds, during the disbursement has been processed.

In the oil supply apparatus 10 of a self-service system configured as described above provided with the change payer 30 and the oil supply setup apparatus 40 to settle the oil supply change in cash, the clients inserts the cash in the bill processor 31 and the coin processor 32 in accordance with the instruction image frame indicated on the touch panel indicator 43 provided to the oil supply setup apparatus 40. In addition, setting the content of the oil supply such as the oil type and the oil supply quantity or the like and taking off the oil supply nozzle 13 from the nozzle hanger 14, the oil supply has been started. After a certain oil supply, if the oil supply nozzle 13 is hung on the nozzle hanger 14 and if the change is needed, the change is disbursed from the bill processor 31 or the coin processor 32 of the change payer 30 after lapse of a certain time. Accordingly, the clients can easily perform a cash transaction on site in cash after the completion of the oil supply even if the clients enjoy the oil supply service in cash.

It is possible to apply the present invention to the oil supply apparatus of a self-service system, particularly, to the oil supply apparatus having the change payer that can perform the cash transaction on site in cash.

What is claimed is:

1. An oil supply apparatus, comprising: an oil supply setup apparatus for setting the oil supply in order for clients themselves to carry out the oil supply operation; an oil supply mechanism for controlling the oil supply operation on the basis of the oil supply setup content set by the oil supply setup apparatus; and a change payer for settling the oil supply charge in cash due to setting of the oil supply of the oil supply setup apparatus in one main body case;
wherein the change payer carries out the process for receiving a cash and disbursing the cash as the change after the completion of the oil supply work.

2. The oil supply apparatus according to claim 1,
wherein the change payer has a bill processor for receiving money by a bill and disbursing the cash when the change is needed of the bill and a coin processor for receiving the money by a coin and disbursing the cash when the change is needed of the coin.

3. The oil supply apparatus according to claim 1,
wherein the oil supply setup apparatus, the oil supply mechanism, and the change payer are respectively connected to a POS terminal that is arranged away from the main body case through signal lines; the POS terminal receives the oil supply setup content that is set by the oil supply setup apparatus and receives the money amount information about the money received by the change payer; the POS terminal transmits a signal for allowing oil supply to the oil supply mechanism on the basis of the oil supply setup content and receives an oil supply finishing signal from the oil supply mechanism; and the POS terminal transmits a signal for instructing the change disbursement to the change payer if the change is needed.

4. The oil supply apparatus according to claim 3, wherein the change payer is connected to the oil supply mechanism through a signal line for receiving a signal relating to the oil supplying state, and when it receives the signal for instructing the change disbursement from the POS terminal after a signal for a temporal stop of the oil supply received by the signal line, the change payer carries out the disbursement process to make the shift to an idling state after lapse of a certain time.

5. The oil supply apparatus according to claim 1,
wherein the oil supply mechanism has an oil supply quantity indicator configured by a liquid crystal display equipped with a back light and an outside light sensor for detecting the brightness of the outside light; and the oil supply mechanism controls the brightness of the back light of the oil supply quantity indicator on the basis of the outside light detected by the outside light sensor.

6. The oil supply apparatus according to claim 1,
wherein the oil supply mechanism has an oil supply quantity indicator configured by a light-emitting diode and an outside light sensor for detecting the brightness of the outside light; and the oil supply mechanism controls the indicated color of the light-emitting diode of the oil supply quantity indicator on the basis of the outside light detected by the outside light sensor.

7. The oil supply apparatus according to claim 1,
wherein an integrating indicator for indicating the integrating amount of the oil supply amount to be measured by the flow meter is attached so that clients can view the integrating amount through an inspection window covered with a polarization plate.
